(19) United States
(12) Patent Application Publication
(10) Pub. No.: US 2025/0251909 A1
(43) Pub. Date: Aug. 7, 2025

(54) SYSTEM, CIRCUIT AND METHOD FOR DATA PROCESSING

(71) Applicants: TAIWAN SEMICONDUCTOR MANUFACTURING COMPANY, LTD., Hsinchu (TW); NATIONAL TSING HUA UNIVERSITY, HSINCHU CITY (TW)

(72) Inventors: Win-San KHWA, Taipei City (TW); Ping-Chun WU, Taichung City (TW); Jui-Jen WU, Hsinchu (TW); Meng-Fan CHANG, Taichung City (TW)

(73) Assignees: TAIWAN SEMICONDUCTOR MANUFACTURING COMPANY, LTD., Hsinchu (TW); NATIONAL TSING HUA UNIVERSITY, HSINCHU CITY (TW)

(21) Appl. No.: 18/672,779

(22) Filed: May 23, 2024

Related U.S. Application Data
(60) Provisional application No. 63/549,766, filed on Feb. 5, 2024.

(51) Int. Cl. G06F 7/487; G06F 5/01; G06F 7/22; G06F 7/485

(52) U.S. Cl. CPC G06F 7/4876; G06F 5/012; G06F 7/22; G06F 7/485

(57) ABSTRACT

A circuit for data processing is provided. The circuit comprises a dual-mode adder, a max finder circuit, a zone detector circuit and an alignment circuit. The dual-mode adder generates products between first exponents of first floating point numbers and second exponents of second floating point numbers. The max finder circuit finds a maximum among first portions of the products. The zone detector circuit classify the first portions into zones by comparing the first portions and the maximum. The alignment circuit align first mantissas of the first floating point numbers according to the zones and second portions of the products to generate aligned mantissas for a floating point number operation.

### CROSS REFERENCE

The present application claims priority to U.S. Provisional Application No. 63/549,766, filed on Feb. 5, 2024, which is herein incorporated by reference in its entirety.

### BACKGROUND

A floating point number is typically represented by three components: sign, exponent and mantissa. When performing an addition or a subtraction of two floating point numbers, an alignment of exponent and mantissa is necessary. Specifically, before an addition or a subtraction of significands of two floating point numbers, exponents of the two floating point numbers must be adjusted to be equal to each other and mantissas of the two floating point numbers are shifted according to the adjustment.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system in accordance with various embodiments of the present disclosure.

FIG. 2 is a schematic diagram of the data process circuit corresponding to FIG. 1, in accordance with various embodiments of the present disclosure.

FIG. 3 is a flowchart diagram of a method for operating the data process circuit as shown in FIG. 2, in accordance with some embodiments of the present disclosure.

FIG. 4A is a schematic diagram of the alignment operation corresponding to the data process circuit of FIGS. 1-2 and the method of FIG. 3, in accordance with some embodiments of the present disclosure.

FIG. 4B is a table of the alignment operation corresponding to the data process circuit of FIGS. 1-2 and the method of FIG. 3, in accordance with some embodiments of the present disclosure.

FIG. 5 is a schematic diagram of a data process circuit configured with respect to the data process circuit corresponding to FIGS. 1-3, 4A-4B, in accordance with various embodiments of the present disclosure.

FIGS. 6-7 are schematic diagram of tables for the alignment operation corresponding to the data process circuits of FIGS. 1-2, 5 and the method of FIG. 3, in accordance with various embodiments of the present disclosure.

FIG. 8 is a schematic diagram of a table for the alignment operation corresponding to the data process circuits of FIGS. 1-2, 5 and the method of FIG. 3, in accordance with various embodiments of the present disclosure.

FIGS. 9A and 9B are a schematic diagram of a floating point operation of the system corresponding to FIGS. 1-8, in accordance with various embodiments of the present disclosure.

FIG. 10 is a schematic diagram of the zone detector circuit and the operation circuit corresponding to FIGS. 1-8 and 9A-9B, in accordance with various embodiments of the present disclosure.

FIGS. 11A and 11B are schematic diagrams of operations of the operation circuit corresponding to FIGS. 1-3, 4A-4B, 5-8 and 9A-9B, in accordance with various embodiments of the present disclosure.

FIG. 12A is a schematic diagram of an example of the floating mode corresponding to the system of FIGS. 1-3, 4A-4B, 5-8, 9A-9B, 10 and 11A-11B, in accordance with various embodiments of the present disclosure.

FIG. 12B is a schematic diagram of an example of the floating mode corresponding to the system of FIGS. 1-3, 4A-4B, 5-8, 9A-9B, 10 and 11A-11B, in accordance with various embodiments of the present disclosure.

FIG. 13 is a schematic diagram of a system configured with respect to the system corresponding to FIGS. 1-3, 4A-4B, 5-8, 9A-9B, 10, 11A-11B and 12A-12B, in accordance with various embodiments of the present disclosure.

FIG. 14 is a schematic diagram of the system corresponding to FIG. 13, in accordance with various embodiments of the present disclosure.

FIG. 15 is a flowchart diagram of a method for operating the system corresponding to FIGS. 13 and 14, in accordance with various embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

This application relates to floating point data processing. In high-performance computing applications, it is often necessary to perform large amounts of floating point number operations. To achieve high speed and performance, some systems such as compute-in-memory (CIM) system and near-memory-computing (NMC) system may include floating point operation circuits for computing floating point number operations and floating point process circuits that generate preprocessed floating point data as input for the floating point operation circuits. For example, a floating point process circuit may generate preprocessed floating point data with mantissa aligned as input of a floating point operation circuit that performs additions and subtractions of floating point numbers.

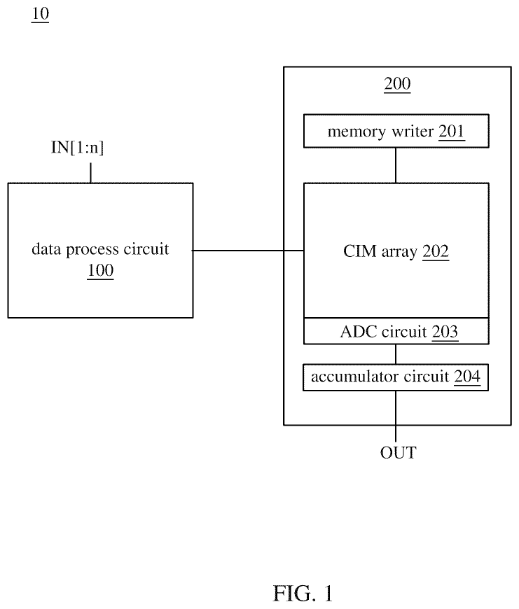

Reference is now made to FIG. 1. FIG. 1 is a schematic diagram of a system 10 in accordance with various embodiments of the present disclosure. In some embodiments, the system 10 is a CIM system. The system 10 includes a data process circuit 100 and an operation circuit 200. In some embodiments, the data process circuit 100 is a floating point process circuit and the operation circuit 200 is a floating point operation circuit. In some embodiments, the operation circuit 200 is implemented by a memory device performing CIM operation. The operation circuit 200 performs floating point number operations.

In some embodiments, the data process circuit 100 aligns a number “n” of floating point numbers IN[1] to IN[n] to generate aligned mantissas IN_{MA}[1] to IN_{MA}[n] of the floating point numbers IN[1] to IN[n] as inputs to the operation circuit 200. In some embodiments, the operation circuit 200 performs multiply-and-accumulate (MAC) operations (dot product operations) to the floating point numbers IN[1] to IN[n] and floating point numbers W[1] to W[n] to generate a MAC result as an output OUT. In other embodiments, the operation circuit 200 performs MAC operations to the aligned mantissas IN_{MA}[1] to IN_{MA}[n] and mantissas W_{M}[1] to W_{M}[n] of the floating point numbers W[1] to W[n] to generate a MAC result as the output OUT. In some embodiments, the floating point numbers IN[1] to IN[n] are activations of an neural network and the floating point numbers W[1] to W[n] are weights of the neural network. In some embodiments, the floating point numbers IN[1] to IN[n] correspond to media information (e.g., images, audio, video data) or electrical signals for detection, classification, recognition, adjustment, conversion or any suitable applications. The output OUT corresponds to an inference result of the neural network.

For practical applications, the operation circuit 200 with the neural network in the disclosure can be utilized in various fields such as machine vision, image classification, or data classification. For example, the operation circuit 200 and the neural network can be used in classifying medical images. For example, they can be used to classify X-ray images in normal conditions, with pneumonia, with bronchitis, or with heart disease. The methods can also be used to classify ultrasound images with normal fetuses or abnormal fetal positions. On the other hand, the operation circuit 200 and the neural network can also be used to classify images collected in automatic driving, such as distinguishing normal roads, roads with obstacles, and road conditions images of other vehicles. Furthermore, the operation circuit 200 and the neural network and the neural network can be utilized in other similar fields, such like music spectrum recognition, spectral recognition, big data analysis, data feature recognition and other related machine learning fields.

As shown in FIG. 1, in some embodiments, the operation circuit 200 includes a memory writer 201, a compute-in-memory (CIM) array 202, an analog-to-digital converter (ADC) circuit 203 and an accumulator circuit 204. The memory writer 201 is coupled to the CIM array 202. The CIM array 202 is coupled to the ADC circuit 203. The ADC circuit 203 is coupled to the accumulator circuit 204. It should be understood that, in the scope of the present disclosure, the description of “coupling” here includes any direct and indirect connection means. Therefore, if a first element is described as being coupled to a second element, it means that the first element can be directly connected to the second element through electrical connection or through other elements or connections.

In some embodiment, the CIM array 202 includes memory cells configured to store weights of a neural network and receive activation of the neural network as input. In some embodiments, memory cells configured to store activation of a neural network and receive weight of the neural network as input. The memory cells includes Non-volatile RAM (RRAM,SRAM) and volatile RAM (DRAM) or other suitable memory.

The memory writer 201 writes the floating point numbers W[1] to W[n] or the mantissas W_{M}[1] to W_{M}[n] to the CIM array 202. The CIM array 202 receives the aligned mantissas IN_{MA}[1] to IN_{MA}[n] as inputs and performs product-sum operations of the aligned mantissa IN_{MA}[1] to IN_{MA}[n] and the mantissas W_{M}[1] to W_{M}[n] stored in the memory cells of the CIM array 202. The ADC circuit 203 converts the results of the CIM array 202 from analog to digital. The accumulator circuit 204 accumulates corresponding results from the ADC circuit 203 to generate a MAC result of the floating point numbers IN[1] to IN[n] and the floating point numbers W[1] to W[n] or a MAC result of the aligned mantissas IN_{MA}[1] to IN_{MA}[n] and the mantissas W_{M}[1] to W_{M}[n].

The configurations of FIG. 1 are given for illustrative purposes. Various implements are within the contemplated scope of the present disclosure and. For example, in some embodiments, the system 10 further includes a floating point compression circuit coupled between the data process circuit 100 and the CIM array 202. In some embodiments, the operation circuit 200 further includes a multiplexer (MUX) circuit coupled between the CIM array 202 and the ADC circuit 203.

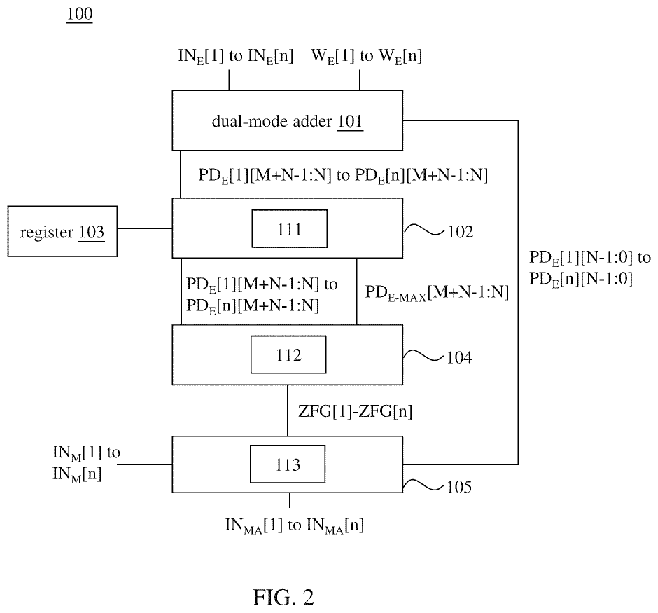

Reference is now made to FIG. 2. FIG. 2 is a schematic diagram of the data process circuit 100 corresponding to FIG. 1, in accordance with various embodiments of the present disclosure. With respect to the embodiments of FIG. 1, like elements in FIG. 2 are designated with the same reference numbers for ease of understanding. The specific operations of similar elements, which are already discussed in detail in above paragraphs, are omitted herein for the sake of brevity.

In some embodiments, before a MAC operation between the floating point numbers IN[1] to IN[n] and the floating point numbers W[1] to W[n], the data process circuit 100 performs a mantissa alignment operation to the floating point numbers IN[1] to IN[n] according to exponents IN_{E}[1] to IN_{E}[n] of the floating point numbers IN[1] to IN[n] and exponents W_{E}[1] to W_{E}[n] of the floating point numbers W[1] to W[n]. In the mantissa alignment operation, the data process circuit 100 aligns the mantissas IN_{M}[1] to IN_{M}[n] to generate the aligned mantissas IN_{MA}[1] to IN_{MA}[n] respectively.

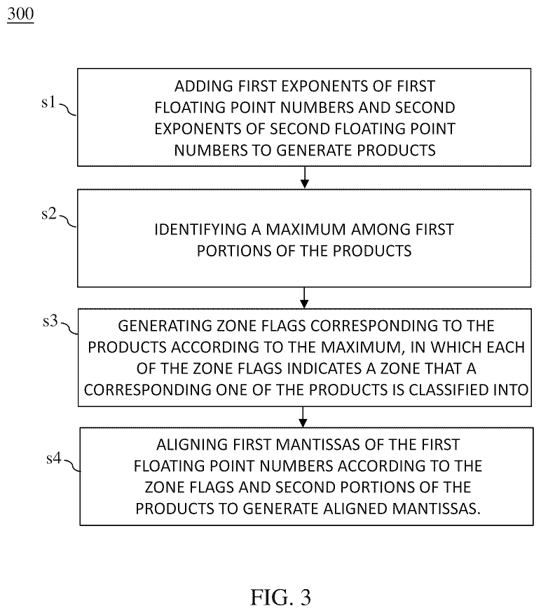

For illustration, the data process circuit 100 includes a dual-mode adder 101, a max finder circuit 102, a register 103, a zone detector circuit 104 and an alignment circuit 105. As shown in FIG. 2, the dual-mode adder 101 is coupled to the max finder circuit 102 and the alignment circuit 105. The max finder circuit 102 is coupled to the register 103 and the zone detector circuit 104. The zone detector circuit 104 is coupled to the alignment circuit 105. Operations of the data process circuit 100 would be described with reference to FIG. 3 in the following paragraphs.

Reference is now made to FIG. 2 and FIG. 3. FIG. 3 is a flowchart diagram of a method 300 for operating the data process circuit 100 as shown in FIG. 2, in accordance with some embodiments of the present disclosure. It is understood that additional steps can be provided before, during, and after the steps shown by FIG. 3, and some of the steps described below can be replaced or eliminated, for additional embodiments of the method 300. The order of the steps may be interchangeable. Throughout the various views and illustrative embodiments, like reference numbers are used to designate like elements. The method 300 includes steps s1-s4 that are described below with reference to the data process circuit 100, corresponding to FIG. 2.

In step s1, a product PD_{E}[i] of an exponent IN_{E}[i] and an exponent W_{E}[i] is generated, in which the number “i” is among the numbers “1” to “n”. Specifically, the dual-mode adder 101 receives the exponents IN_{E}[1] to IN_{E}[n] and the exponents W_{E}[1] to W_{E}[n] and adds the exponents IN_{E}[1] to IN_{E}[n] and the exponents W_{E}[1] to W_{E}[n] respectively to generate products PD_{E}[1] to PD_{E}[n] of the exponents IN_{E}[1] to IN_{E}[n] and the exponents W_{E}[1] to W_{E}[n].

In step s2, a maximum product exponent search is performed to identify a maximum PD_{E-MAX}[M+N−1:N] among the more-significant “M” bits PD_{E}[1] [M+N−1:N] to PD_{E}[n] [M+N−1:N]. Specifically, the max finder circuit 102 performs the maximum product exponent search using the more-significant “M” bits among the total “M+N” bits of each of the products PD_{E}[1] to PD_{E}[n], M and N being positive integer. For example, the max finder circuit 102 receives the more-significant “M” bits PD_{E}[1] [M+N−1:N] to PD_{E}[n] [M+N−1:N] of the products PD_{E}[1] to PD_{E}[n] and find the maximum PD_{E-MAX} [M+N−1:N] among the more-significant “M” bits PD_{E}[1] [M+N−1:N] to PD_{E}[n] [M+N−1:N]. In some embodiments, the number “N” is configured as the logarithm of a number of mantissa bit width of mantissas IN_{M}[1] to IN_{M}[n] to a base two.

In some embodiments, the max finder circuit 102 includes a comparator circuit 111. that compares two of the more-significant “M” bits PD_{E}[1] [M+N−1:N] to PD_{E}[n] [M+N−1:N] (e.g., PD_{E}[1] [M+N−1:N] and PD_{E}[2] [M+N−1:N]) and determines a greater one as a temporary maximum stored in the register 103. Then, the comparator circuit 111 compares the temporary maximum and one of the remaining more-significant “M” bits PD_{E}[1] [M+N−1:N] to PD_{E}[n] [M+N−1:N] to determine a greater one thereof to store in the register 103 as a updated temporary maximum. The comparator circuit 111 repeats such comparison to find the maximum PD_{E-MAX}[M+N−1:N] among the more-significant “M” bits PD_{E}[1] [M+N−1:N] to PD_{E}[n] [M+N−1:N].

In one example, the total “M+N” bits of each of the products PD_{E}[1]-PD_{E}[n] are nine bits. The more-significant “M” bits are six bits. The less-significant “N” bits are three bits.

Compared to some approaches that using full “M+N” bits of each of the products PD_{E}[1] to PD_{E}[n] to performs the maximum product exponent search, the max finder circuit 102 performing the maximum product exponent search using only the more-significant “M” bits simplifies hardware design to reduce area and energy usage.

In step s3, the zone detector circuit 104 generates zone flags ZFG[1] to ZFG[n] corresponding to the products PD_{E}[1] to PD_{E}[n] according to the maximum PD_{E}-MAX [M+N−1:N]. Each of the zone flags ZFG[1] to ZFG[n] indicates a zone that a corresponding one of the products PD_{E}[1] to PD_{E}[n] is classified into. Further details of the step s3 are described in the following paragraphs.

In some embodiments, the zone detector circuit 104 classifies each of the products PD_{E}[1] to PD_{E}[n] into one of “K” zones. Specifically, the zone detector circuit 104 receives the more-significant “M” bits PD_{E}[1] [M+N−1:N] to PD_{E}[n] [M+N−1:N] and the maximum PD_{E-MAX}[M+N−1:N] and classifies each of the products PD_{E}[1] to PD_{E}[n] into one of “K” zones according to the more-significant “M” bits PD_{E}[1] [M+N−1:N] to PD_{E}[n] [M+N−1:N] and the maximum PD_{E-MAX}[M+N−1:N]. In some embodiments, the zone detector circuit 104 classifies the product PD_{E}[i] into one of “K” zones according to comparisons between the more-significant “M” bits PD_{E}[i] [M+N−1:N] and references PD_{E-REF1}-PD_{E-REFK}.

In some embodiments, the reference P_{DE-REF1} is a binary number of “M+N” bits, in which the “M” more-significant bits are the maximum PD_{E-MAX}[M+N−1:N] and the “N” less-significant bits are “N” bits of binary ones. The reference PD_{E-REF2} is configured as the reference P_{DE-REF1} minus a decimal number “2^{N}”, the reference P_{DE-REF3} is configured as the reference PD_{E-REF1} minus a decimal number “2×2^{N}” . . . , and the reference PD_{E-REFK} is configured as the reference PD_{E-REF1} minus a decimal number “(K−1)×2^{N}”.

In some embodiments, the zone detector circuit 104 includes an M-bit subtractor 112 to generate the references PD_{E-REF1}-PD_{E-REFK} by performing subtractions to the maximum PD_{E-MAX}[M+N−1:N]. For example, the subtractor 112 subtracts the maximum PD_{E-MAX}[M+N−1:N] with a decimal number one to generate the “M” more-significant bits of the reference PD_{E-REF2}, the subtractor 112 subtracts the maximum PD_{E-MAX}[M+N−1:N] with a decimal number two to generate the “M” more-significant bits of the reference PD_{E-REF3} . . . and the subtractor 112 subtracts the maximum PD_{E-MAX} [M+N−1:N] with a decimal number K−1 to generate the “M” more-significant bits of the reference PD_{E-REFK}. Then, the zone detector circuit 104 pads each of the “M” more-significant bits of the references PD_{E-REF2} to PD_{E-REFK} with N bits of binary ones to generate the references PD_{E-REF2} to PD_{E-REFK}.

In some embodiments, the zone detector circuit 104 classifies the product PD_{E}[i] into a zone-1 among the “K” zones when the product PD_{E}[i] is smaller than or equal to the reference PD_{E-REF1} and greater than the reference PD_{E-REF2}, classifies the product PD_{E}[i] into a zone-2 among the “K” zones when the product PD_{E}[i] is smaller than or equal to the reference PD_{E-REF2} and greater than the reference PD_{E-REF3} . . . , classifies the product PD_{E}[i] into a zone-K−1 among the “K” zones when the product PD_{E}[i] is smaller than or equal to the reference PD_{E-REFK-1} and greater than the reference PD_{E-REFK}, and classifies the product PD_{E}[i] into a zone-K among the “K” zones when the product PD_{E}[i] is smaller than or equal to the reference PD_{E-REFK}.

In some embodiments, the zone detector circuit 104 includes a “M” bits comparator. The zone detector circuit 104 classifies the product PD_{E}[i] into the zone-1 when the more-significant “M” bits PD_{E}[i] [M+N−1:N] is smaller than or equal to the maximum PD_{E-MAX}[M+N−1:N] and greater than the maximum PD_{E-MAX}[M+N−1:N] minus decimal number one, classifies the product PD_{E}[i] into the zone-2 when the more-significant “M” bits PD_{E}[i] [M+N−1:N] is smaller than or equal to the maximum PD_{E-MAX}[M+N−1:N] minus decimal number one and greater than the maximum PD_{E}-MAX [M+N−1:N] minus decimal number two . . . , classifies the product PD_{E}[i] into the zone−K−1 when the more-significant “M” bits PD_{E}[i] [M+N−1:N] is smaller than or equal to the maximum PD_{E-MAX}[M+N−1:N] minus decimal number “K−1” and greater than the maximum PD_{E-MAX}[M+N−1:N] minus decimal number “K”, and classifies the product PD_{E}[i] into a zone-K among the “K” zones when the product PD_{E}[i] is smaller than or equal to the decimal number “K”.

In some embodiments, the number “K” of zones are determined according to a bit number (bit width) “B” of each of the aligned mantissas IN_{MA}[1] to IN_{MA}[n]. In some embodiments, the number “K” equals to the bit number of each of the aligned mantissas IN_{MA}[1] to IN_{MA}[n] divided by “2^{N}” and then plus 1 (K=(B/2^{N})+1).

In some embodiments, the zone detector circuit 104 generates the zone flags (zone bits) ZFG[1] to ZFG[n] indicating the zones corresponding to the products PD_{E}[1] to PD_{E}[n] respectively. In some embodiments, each of the zone flags ZFG[1] to ZFG[n] includes one of the numbers “1” to “K” in binary form to indicate one of the zone-1 to the zone-K respectively. For example, when the number of zones equals to three, each of the zone flags ZFG[1] to ZFG[n] includes one of the binary numbers “01”, “10” and “11” to indicate the zone-1 to the zone-3 respectively. When the product PD_{E}[1] is classified into the zone-1, the zone detector circuit 104 generates the zone flag ZFG[1] that includes the binary number “11”.

In step s4, the alignment circuit 105 aligns tha mantissas IN_{M}[1] to IN_{M}[N] according to the zone flags ZFG[1] to ZFG[N] and the “N” less-significant bits PD_{E}[1] [N−1:0] to PD_{E}[N] [N−1:0] to generate the aligned mantissas IN_{MA}[1] to IN_{MA}[n].

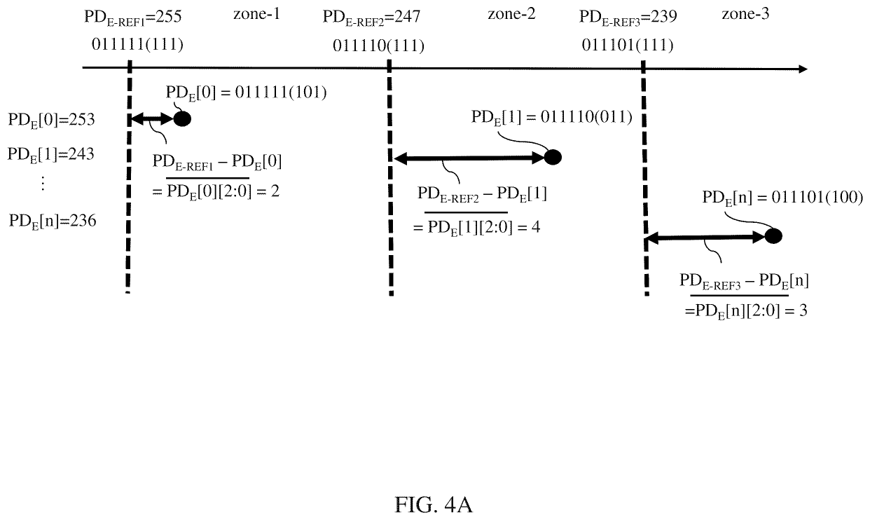

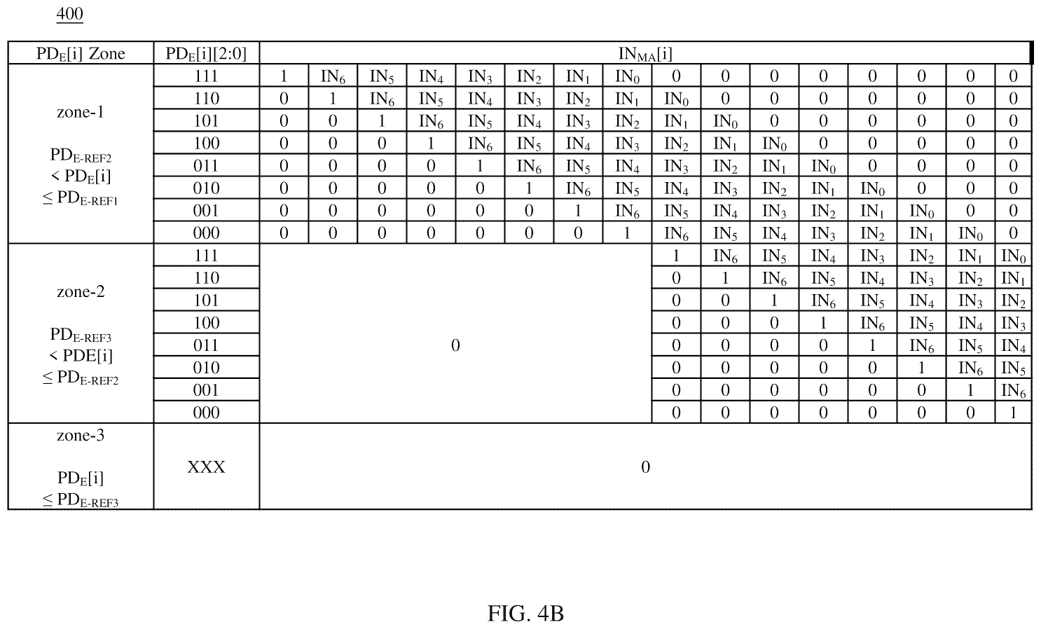

The alignment operation is performed to shift the mantissas IN_{M}[i]. The mantissas IN_{M}[i] is shifted according to “relative exponent value” which is defined as the difference between the product PD_{E}[i] and an upper boundary of the zone of the product PD_{E}[i]. For example, when the product PD_{E}[1] is in the zone-1, the relative exponent value is the difference between the product PD_{E}[1] and the reference P_{DE-REF1}, in which the reference P_{DE-REF1} is the upper boundary of the zone-1. According to embodiments of the present disclosure, the relative exponent value corresponding to the mantissas IN_{M}[i] is equal to inverse of the “N” less-significant bits PD_{E}[i] [N−1:0]. An example of the alignment operation is described below with further reference to FIGS. 4A-4B.

Reference is now made to FIGS. 2-3, 4A-4B. FIG. 4A is a schematic diagram of the alignment operation corresponding to the data process circuit 100 of FIGS. 1-2 and the method 300 of FIG. 3, in accordance with some embodiments of the present disclosure. FIG. 4B is a table 400 of the alignment operation corresponding to the data process circuit 100 of FIGS. 1-2 and the method 300 of FIG. 3, in accordance with some embodiments of the present disclosure. With respect to the embodiments of FIGS. 1-3, like elements in FIGS. 4A-4B are designated with the same reference numbers for ease of understanding.

In the example shown in FIG. 4A, the bit width of each of the products PD_{E}[1]-PD_{E}[n] is nine. The number “M” is six and the number “N” is three. The products PD_{E}[1]-PD_{E}[n] are classified into three zones zone-1 to zone-3. The PD_{E-MAX}[M+N−1:N] is six bits “011111”. Accordingly, the reference PD_{E-REF1} is “011111111”, the reference PD_{E-REF2} is “011110111” and the reference PD_{E-REF3} is “011101111”. The product PD_{E}[0] is “0111111101”. The product PD_{E}[1] is “0111110011”. The product PD_{E}[n] is “0111101100”.

The product PD_{E}[0], being between the references P_{DE-REF1} and PD_{E-REF2}, is classified into the zone-1 in step s3. Then, in step s4, the difference between the references PD_{E-REF1} (upper boundary of the zone-1) and the product PD_{E}[0] is determined according to the less significant three bit of the product PD_{E}[0]. As shown in FIG. 4A, the binary number “010”, corresponding to the difference of two, is the inverse of the less significant three bit “101”. The shifted bits to align the mantissa IN_{M}[0] is determined as two according to the difference between the references PD_{E-REF1} and the product PD_{E}[0] and the product PD_{E}[0] classified into zone-1.

Similarly, the product PD_{E}[1], being between the references PD_{E-REF2} and PD_{E-REF3}, is classified into the zone-1 in step s3. In step s4, the difference between the references PD_{E-REF2} (upper boundary of the zone-2) and the product PD_{E}[1] is determined according to the less significant three bit of the product PD_{E}[1]. As shown in FIG. 4A, the binary number “100”, corresponding to the difference of four, is the inverse of the less significant three bit “011”. The shifted bits to align the mantissa IN_{M}[1] is determined as four plus eight according to the difference between the references PD_{E-REF1} and the product PD_{E}[0] and the product PD_{E}[0] classified into zone-2.

The product PD_{E}[n], being smaller than the references PD_{E-REF3}, is classified into the zone-3 in step s3. Then, in step s4, the difference between the references PD_{E-REF3} (upper boundary of the zone-3) and the product PD_{E}[n] is determined according to the less significant three bit of the product PD_{E}[n]. As shown in FIG. 4A, the binary number “011”, corresponding to the difference of three, is the inverse of the less significant three bit “100”. The shifted bits to align the mantissa IN_{M}[n] is determined as three plus sixteen according to the difference between the references PD_{E-REF3} and the product PD_{E}[0] and the product PD_{E}[0] classified into zone-3.

In the alignment operation of step s4, with reference to FIG. 2, the alignment circuit 105 receives the zone flags ZFG[1] to ZFG[n] from the zone detector circuit 104 and further receives the less-significant “N” bits PD_{E}[1] [N−1:0] to PD_{E}[n] [N−1:0] from the dual-mode adder 101. The zone detector circuit 104 further aligns the mantissas IN_{M}[1]-IN_{M}[n] according to the zone flags ZFG[1]-ZFG[n] and the less-significant “N” bits PD_{E}[1] [N−1:0] to PD_{E}[n] [N−1:0] to generate the aligned mantissas IN_{MA}[1]-IN_{MA}[n].

In some embodiments, the alignment circuit 105 generates the aligned mantissas IN_{MA}[1]-IN_{MA}[n] by padding the mantissas IN_{M}[1] to IN_{M}[n] with bits of binary zeros on the most significant bit (MSB) side according to the zone flags ZFG[1] to ZFG[n] and the less-significant “N” bits PD_{E}[1] [N−1:0] to PD_{E}[n] [N−1:0].

In some embodiments, the alignment circuit 105 generates aligned floating numbers IN_{A}[1] to IN_{A}[n] with the aligned mantissas IN_{MA}[1] to IN_{MA}[n]. Each of the floating numbers IN_{A}[1] to IN_{A}[n] has an exponent of the reference PD_{E-REF1}. In some embodiments, the operation circuit 200 performs a floating number operation to the floating numbers IN_{A}[1] to IN_{A}[n].

In some embodiments, with reference to FIG. 4B, when the product PD_{E}[i] is in the zone-1, the mantissa IN_{M}[i] is padded with bits of binary zeros on the MSB side. The number of the padded bits of binary zeros is according to the bitwise inverse of the less-significant “N” bits PD_{E}[i] [N−1:0]. In some embodiments, the number of the padded bits of binary zeros is equal to the number of the bitwise inverse of the less-significant “N” bits PD_{E}[i] [N−1:0] in decimal form. For example, in some embodiments in which the number “N” is three and the less-significant “N” bits PD_{E}[i] [N−1:0] are three bits of “101”, the number of the padded bits of binary zeros equals to two. The number two corresponds to the decimal form of bits “010”, in which the bits “010” are bitwise inverse of the bits “101”. In this embodiments, the mantissa IN_{M}[i] is padded with two bits from the MSB side.

When the product PD_{E}[i] is in the zone-2, the mantissa IN_{M}[i] is padded with bits of binary zeros on the MSB side. However, the number of the padded bits of binary zeros is equal to “(2-1)×2^{N}” plus the number of the bitwise inverse of the less-significant “N” bits PD_{E}[i] [N−1:0] in decimal form. For example, in some embodiments in which the number “N” is three and the less-significant “N” bits PD_{E}[i] [N−1:0] are three bits of “101”, the number of the padded bits of binary zeros equals to eight plus two. The number eight is equal to 23 and the number two corresponds to the decimal form of bits “010”, in which the bits “010” are bitwise inverse of the bits “101”. In this embodiments, the mantissa IN_{M}[i] is padded with eight plus two bits from the MSB side.

Similarly, when the product PD_{E}[i] is in the zone-3, the number of the padded bits of binary zeros is equal to “(3-1)×2^{N}” plus the number of the bitwise inverse of the less-significant “N” bits PD_{E}[i] [N−1:0] in decimal form.

For the cases of the product PD_{E}[i] is in the zone-4 to zone-K, the number of the padded bits of binary zeros is configured in a similar manner as described above. For example, when the product PD_{E}[i] is in the zone-K, the number of the padded bits of binary zeros is equal to “(K−1)×2^{N}” plus the number of the bitwise inverse of the less-significant “N” bits PD_{E}[i] [N−1:0] in decimal form.

As described above, the relative exponent value (i.e., the number of bit shift of the mantissas IN_{M}[i] to generate the aligned mantissas IN_{MA}[i]) is determined according to the inverse of the less-significant “N” bits PD_{E}[1] [N−1:0] to PD_{E}[n] [N−1:0]. Therefore, no subtractor is needed in the alignment circuit 105 to calculate the relative exponent value. In some embodiments, the alignment circuit 105 includes a inverter 113 receiving the less-significant “N” bits PD_{E}[1] [N−1:0] to PD_{E}[n] [N−1:0] to generate the inverse of the less-significant “N” bits PD_{E}[1] [N−1:0] to PD_{E}[n] [N−1:0] for determining the numbers of the padded bits of binary zeros as described above.

In some embodiments, when the number of the padded bits of binary zeros is equal to or greater than the number of the total bits of the mantissa IN_{M}[i], the aligned mantissa IN_{MA}[i] is set to zero.

In some embodiments, when the product PD_{E}[i] is in the zone-K, the alignment is skipped and the aligned mantissa IN_{MA}[i] is directly set to zero.

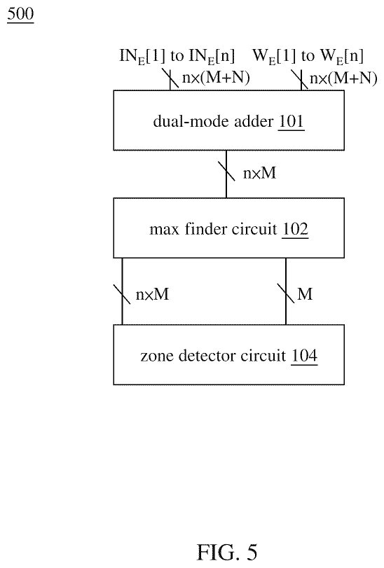

Reference is now made to FIG. 5. FIG. 5 is a schematic diagram of a data process circuit 500 configured with respect to the data process circuit 100 corresponding to FIGS. 1-3, 4A-4B, in accordance with various embodiments of the present disclosure. With respect to the embodiments of FIGS. 1-3, 4A-4B, like elements in FIG. 5 are designated with the same reference numbers for ease of understanding.

As shown in FIG. 5, the dual-mode adder 101 receives the M+N bits of each of the exponents IN_{E}[1] to IN_{E}[n] through n×(M+N) data lines and the M+N bits of each of the exponents W_{E}[1] to W_{E}[n] through other n×(M+N) data lines.

In some embodiments, the max finder circuit 102 is coupled to the dual-mode adder 101 through n×M data lines to receive the more-significant “M” bits PD_{E}[1] [M+N−1:N] to PD_{E}[n] [M+N−1:N] to performs the maximum product exponent search.

In some embodiments, the zone detector circuit 104 is coupled to the max finder circuit 102 through (n+1)×M data lines to receive the more-significant “M” bits PD_{E}[1] [M+N−1:N] to PD_{E}[n] [M+N−1:N] and the maximum PD_{E-MAX}[M+N−1:N] to performs the zone classification. Instead of using full bits of the products PD_{E}[i] (i.e., using “M+N” data lines) to performs the maximum product exponent search and find a difference between a product maximum and the product PD_{E}[i], the data process circuit 100 provides fewer data transfer, thus providing lower area and energy usage.

In some embodiments, the data lines of the data process circuit 500 are metal lines in metal layers of a semiconductor device. For example, the data lines are in a metal one layer.

The configurations of FIGS. 2-3, 4A-4B and 5 are given for illustrative purposes. Various implements are within the contemplated scope of the present disclosure. For example, in some embodiments, a portion of the dual-mode adder 101 is included in the operation circuit 200.

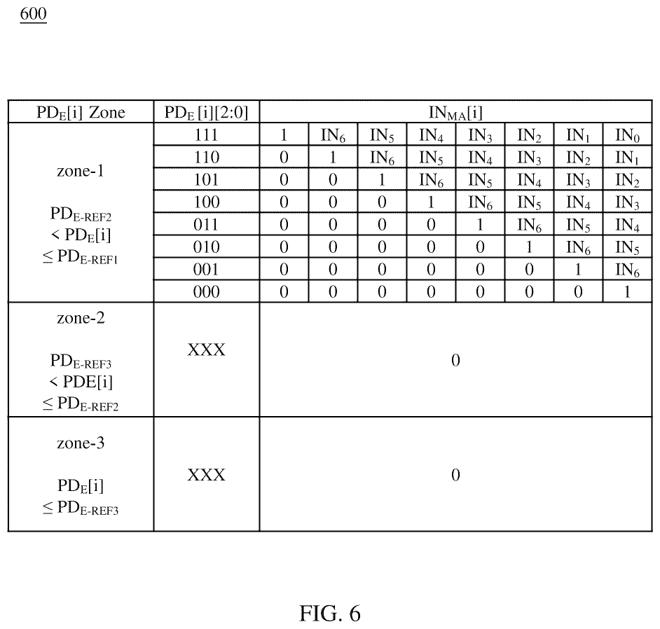

Reference is now made to FIGS. 6-7. FIGS. 6-7 are schematic diagram of tables 600-700 for the alignment operation corresponding to the data process circuits 100 and 500 of FIGS. 1-2, 5 and the method 300 of FIG. 3, in accordance with various embodiments of the present disclosure. With respect to the embodiments of FIGS. 1-5, like elements in FIGS. 6-7 are designated with the same reference numbers for ease of understanding.

In some embodiments, the alignment operation corresponding to the data process circuits 100 and 500 of FIGS. 1-2, 5 and the method 300 of FIG. 3 are configured for a one-phase mode or a two-phase mode. In the one-phase mode, the aligned mantissas IN_{MA}[1] to IN_{MA}[n] have a bit number of the mantissas IN_{M}[1] to IN_{M}[n]. Specifically, the bit number of each of the aligned mantissas IN_{MA}[1] to IN_{MA}[n] is configured equal to the bit number of each of the mantissas IN_{M}[1] to IN_{M}[n].

An example of the alignment operation of the one-phase mode is described hereinafter with reference to the table 600. In this example, the products PD_{E}[1] to PD_{E}[n] are classified into three zones. The number of the padded bits of binary zeros for mantissa alignment is according to the bitwise inverse of the less-significant three bits PD_{E}[1] [2:0] to PD_{E}[n] [2:0]. The bit number of each of the mantissas IN_{M}[1] to IN_{M}[n] is eight. The bit number of each of the aligned mantissas IN_{MA}[1] to IN_{MA}[n] is eight. The mantissa IN_{M}[i] includes eight bits “I, IN₆, IN₅, IN₄, IN₃, IN₂, IN₁, IN₀”.

In the table 600, the first column corresponds to the zone of the product PD_{E}[i]. The second column corresponds to the less-significant three bits PD_{E}[i] [2:0]. The third column corresponds to aligned mantissas IN_{MA}[i] generated by the one-phase mode alignment operation corresponding to the zone and the less-significant three bits PD_{E}[i] [2:0]. For illustration, as shown in table 600, when the product PD_{E}[i] is classified into the zone-1 and its less-significant three bits PD_{E}[i] [2:0] are equal to “101”, the aligned mantissa IN_{MA}[i] equals to the mantissa IN_{M}[i] padded (shifted) with two bits zero from the MSB side, which includes eight bits “0, 0, 1, IN₆, IN₅, IN₄, IN₃, IN₂”. “XXX” in the table 600 means any value of the less-significant three bits PD_{E}[i] [2:0]. When the product PD_{E}[i] is classified into the zone-1, the aligned mantissa IN_{MA}[i] is directly set to zero.

Another example of the alignment operation of the one-phase mode is described hereinafter with reference to the table 700. In this example, the products PD_{E}[1] to PD_{E}[n] are classified into three zones. The number of the padded bits of binary zeros for mantissa alignment is according to the bitwise inverse of the less-significant two bits PD_{E}[1] [1:0] to PD_{E}[n] [1:0]. The bit number of each of the mantissas IN_{M}[1] to IN_{M}[n] is eight. The bit number of each of the aligned mantissas IN_{MA}[1] to IN_{MA}[n] is eight. The mantissa IN_{M}[i] includes eight bits “1, IN₆, IN₅, IN₄, IN₃, IN₂, IN₁, IN₀”.

In the table 700, the first column corresponds to the zone of the product PD_{E}[i]. The second column corresponds to the less-significant three bits PD_{E}[i] [1:0]. The third column corresponds to aligned mantissas IN_{MA}[i] generated by the one-phase mode alignment operation corresponding to the zone and the less-significant two bits PD_{E}[i] [1:0]. For illustration, as shown in table 400, when the product PD_{E}[i] is classified into the zone-1 and its less-significant two bits PD_{E}[i] [1:0] are equal to “10”, the aligned mantissa IN_{MA}[i] equals to the mantissa IN_{M}[i] padded (shifted) with one bits zero from the MSB side, which includes eight bits “0, 1, IN₆, IN₅, IN₄, IN₃, IN₂, IN₁”. When the product PD_{E}[i] is classified into the zone-2 and its less-significant three bits PD_{E}[i] [1:0] are equal to “10”, the aligned mantissa IN_{MA}[i] equals to the mantissa IN_{M}[i] padded (shifted) with four bits plus one bits zero from the MSB side, which includes eight bits “0, 0, 0, 0, 0, 1, IN₆, IN₅”.

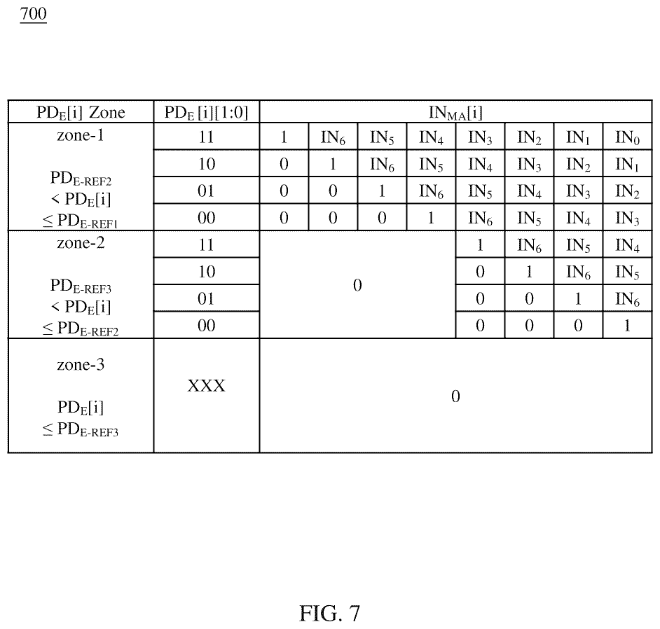

Reference is now made to FIG. 8. FIG. 8 is a schematic diagram of a table 800 for the alignment operation corresponding to the data process circuits 100 and 500 of FIGS. 1-2, 5 and the method 300 of FIG. 3, in accordance with various embodiments of the present disclosure. With respect to the embodiments of FIGS. 1-7, like elements in FIG. 8 are designated with the same reference numbers for ease of understanding.

The table 800 corresponds to the alignment operation of a two-phase mode. In the two-phase mode, each of the aligned mantissa IN_{MA}[1] to IN_{MA}[n] includes phase Ph1 and phase Ph2. The phase Ph1 includes more significant bits with a bit width equal to the bit width of each of the mantissas IN_{M}[1] to IN_{M}[n]. The phase Ph2 includes extension bits for mantissa extension.

An example of the alignment operation of the two-phase mode is described hereinafter with reference to the table 800. In this example, the products PD_{E}[1]-PD_{E}[n] are classified into three zones. The number of the padded bits of binary zeros for mantissa alignment is according to the bitwise inverse of the less-significant three bits PD_{E}[1] [2:0] to PD_{E}[n] [2:0]. The bit number of each of the mantissas IN_{M}[1] to IN_{M}[n] is eight. The bit number of each of the aligned mantissas IN_{MA}[1] to IN_{MA}[n] is sixteen. The mantissa IN_{M}[i] includes eight bits “1, IN₆, IN₅, IN₄, IN₃, IN₂, IN₁, IN₀”.

In the table 800, the first column corresponds to the zone of the product PD_{E}[i]. The second column corresponds to the less-significant three bits PD_{E}[i] [2:0]. The third and fourth columns correspond to the phases Ph1 and Ph2 of the aligned mantissas IN_{MA}[i] generated by the two-phase mode alignment operation corresponding to the zone and the less-significant three bits PD_{E}[i] [2:0].

For illustration, as shown in table 800, when the product PD_{E}[i] is classified into the zone-1 and its less-significant three bits PD_{E}[i] [2:0] are equal to “101”, the aligned mantissa IN_{MA}[i] equals to the mantissa IN_{M}[i] padded (shifted) with two bits zero from the MSB side. The phase Ph1 includes eight bits “0, 0, 1, IN₆, IN₅, IN₄, IN₃, IN₂”. The phase Ph2 includes eight bits “IN₁, IN₀, 0, 0, 0, 0, 0, 0”.

According to various embodiments, the one-phase mode provides higher energy efficiency with no mantissa extension, while the two-phase mode provides better accuracy of the computation of the operation circuit 200 with mantissa extension.

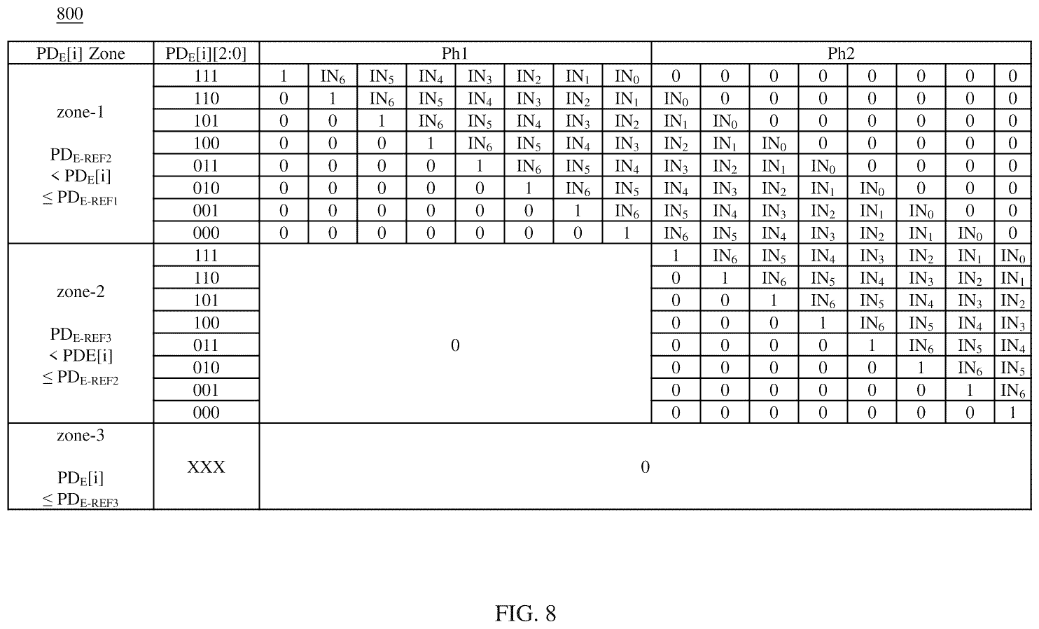

Reference is now made to FIGS. 9A and 9B. FIGS. 9A and 9B are a schematic diagram of a floating point operation of the system 10 corresponding to FIGS. 1-3, 4A-4B, 5-8, in accordance with various embodiments of the present disclosure. In some embodiments, the floating point operations in the phase Ph1 and the phase Ph2 (for example, corresponding to FIG. 8) are performed separately. In some embodiments, the floating point operations to the phase Ph1 and the phase Ph2 are performed in parallel with a pipeline execution.

FIG. 9A depicts an example of a floating point operation in the two-phase mode without a pipeline execution. For illustration, the clock CLK is a clock signal of the system 10. In a task Task1, the system 10 performs a MAC operation to the floating numbers IN[1] to IN[n] and the floating numbers W[1] to W[n]. “EXP” indicates an exponent operation including finding the maximum exponent corresponding to the max finder circuit 102 in FIG. 2, amount of input mantissa shifting bit, and shifting the input mantissa corresponding to the alignment circuit 105 in FIG. 2. “MAN” indicates a mantissa product-sum operation corresponding to the CIM array 202 in FIG. 1. “ADD” indicates a mantissa accumulation operation corresponding to accumulator circuit 204 in FIG. 1.

As shown in FIG. 9A, in a time period from a time t1 to a time t3, the system 10 performs the exponent operation EXP to the floating numbers IN[1] to IN[n], the mantissa product-sum operation MAN to the phase Ph1 of the aligned mantissas IN_{MA}[1] to IN_{MA}[n] and the mantissas W_{M}[1] to W_{M}[n] and the mantissa accumulation operation ADD to the result of the mantissa product-sum operation MAN to the phase Ph1 of the aligned mantissas IN_{MA}[1] to IN_{MA}[n] and the mantissas W_{M}[1] to W_{M}[n]. The system 10 performs the operations from the time t1 to the time t3 to generate a MAC result of the phase Ph1.

Then, in a time period from the time t3 to a time t5, the system 10 performs the mantissa product-sum operation to the phase Ph2 of the aligned mantissas IN_{MA}[1] to IN_{MA}[n] and the mantissas W_{M}[1] to W_{M}[n] and the mantissa accumulation operation ADD to the result of the mantissa product-sum operation MAN to the phase Ph2 of the aligned mantissas IN_{MA}[1] to IN_{MA}[n] and the mantissas W_{M}[1] to W_{M}[n]. The system 10 performs the operations from the time t3 to the time t5 to generate a MAC result of the phase Ph2. The system 10 further generates a complete MAC result of the task Task1 according to the MAC result of the phases Ph1 and Ph2.

FIG. 9B depicts an example of a floating point operation in the two-phase mode with a pipeline execution (performed at the same time). For illustration, in a task Task1, the system 10 performs a MAC operation to the floating numbers IN[1] to IN[n] and the floating numbers W[1] to W[n]. In a task Task2, the system 10 performs a MAC operation to floating numbers IN[n+1] to IN[2n] and floating numbers W[n+1] to W[2n].

As shown in FIG. 9B, in a time period from a time t1 to a time t2, the system 10 performs the exponent operation EXP to the floating numbers IN[1] to IN[n], the mantissa product-sum operation to the phase Ph1 of the aligned mantissas IN_{MA}[1] to IN_{MA}[n] and the mantissas W_{M}[1] to W_{M}[n]. From a time t2 to a time t3, the system 10 performs the mantissa accumulation operation ADD to the result of the mantissa product-sum operation MAN to the phase Ph1 of the aligned mantissas IN_{MA}[1] to IN_{MA}[n] and the mantissas W_{M}[1] to W_{M}[n]. In the time period from the time t2 to time t3, the system 10 further performs the mantissa product-sum operation MAN to the phase Ph2 of the aligned mantissas IN_{MA}[1] to IN_{MA}[n] and the mantissas W_{M}[1] to W_{M}[n] in parallel to the mantissa accumulation operation ADD to the result of the mantissa product-sum operation to the phase Ph1.

From the time t3 to a time t4, the system 10 performs the exponent operation EXP to the floating numbers IN[n+1] to IN[2], the mantissa product-sum operation MAN to the phase Ph1 of the aligned mantissas IN_{MA}[n+1] to IN_{MA}[2n] and the mantissas W_{M}[n+1] to W_{M}[2n]. In the time period from the time t3 to the time t4, the system 10 further performs the mantissa accumulation operation ADD to the result of the mantissa product-sum operation MAN to the phase Ph2 of the aligned mantissas IN_{MA}[1] to IN_{MA}[n] and the mantissas W_{M}[1] to W_{M}[n] in parallel to the exponent operation EXP to the floating numbers IN[n+1] to IN[2n] and the mantissa product-sum operation MAN to the phase Ph1 of the aligned mantissas IN_{MA}[n+1] to IN_{MA}[2n] and the mantissas W_{M}[n+1] to W_{M}[2n]. After the mantissa accumulation operation ADD to the result of the mantissa product-sum operation MAN to the phase Ph2 of the aligned mantissas IN_{MA}[1] to IN_{MA}[n] and the mantissas W_{M}[1] to W_{M}[n], the system 10 further generates a complete MAC result of the task 1 according to the MAC result of the phases Ph1 and Ph2.

As shown in FIGS. 9A and 9B, in some embodiments, the operations with the pipeline execution provides less latency compared to the operations without the pipeline execution. For illustration, the task Task1 with pipeline shown in FIG. 9B is finished earlier than the task Task1 without pipeline shown in FIG. 9A.

The configurations of FIGS. 6-8, 9A and 9B are given for illustrative purposes. Various implements are within the contemplated scope of the present disclosure and. For example, in some embodiments, it takes two clock cycles to finish the mantissa accumulation operation ADD as shown in FIGS. 9A and 9B.

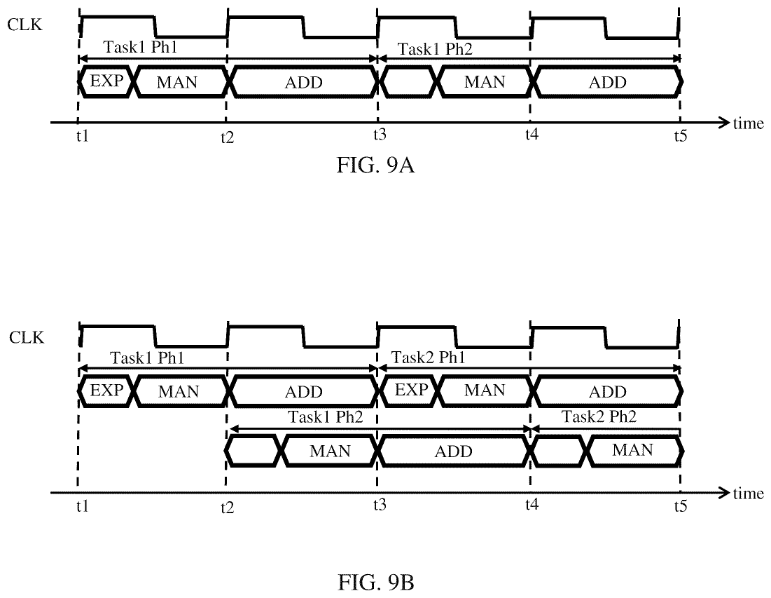

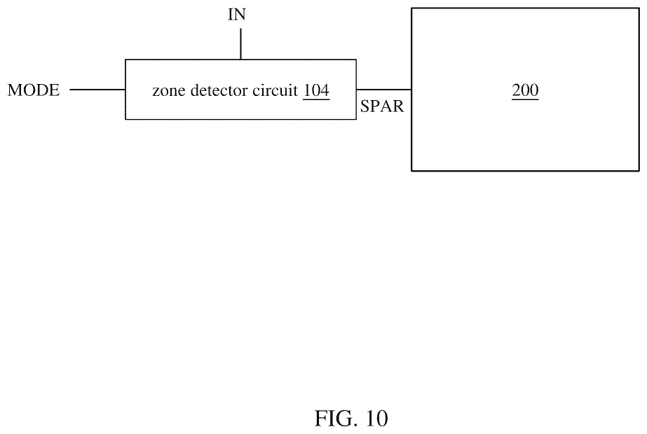

Reference is now made to FIGS. 10, 11A and 11B. FIG. 10 is a schematic diagram of the zone detector circuit 104 and the operation circuit 200 corresponding to FIGS. 1-8 and 9A-9B, in accordance with various embodiments of the present disclosure. FIGS. 11A and 11B are schematic diagrams of operations of the operation circuit 200 corresponding to FIGS. 1-3, 4A-4B, 5-8 and 9A-9B, in accordance with various embodiments of the present disclosure. With respect to the embodiments of FIGS. 1-8 and 9A-9B, like elements in FIG. 10 are designated with the same reference numbers for ease of understanding.

For illustration, in some embodiments, the zone detector circuit 104 further receives a signal MODE indicating a floating point mode or an integer (INT) mode. In the floating point mode, the zone detector circuit 104 performs the exponent product zone classification of floating point number as described in the previous paragraphs.

In the INT mode, the zone detector circuit 104 further receives an integer number IN. In some embodiments, the operation circuit 200 performs a MAC operation of the integer number IN and a weight stored in the CIM array 202. In some embodiments, the integer number IN is processed and the operation circuit 200 performs a MAC operation of the processed integer number IN and a weight stored in the CIM array 202.

In the INT mode, the zone detector circuit 104 performs a sparsity detection to compare the integer IN with zero. When the integer IN is smaller than or equal to zero, the zone detector circuit 104 outputs a signal SPAR having a first value (e.g., binary one) to indicate sparsity aware activate. When the integer IN is greater than zero, the zone detector circuit 104 outputs a signal SPAR having a second value (e.g., binary zero) different from the first value to indicate sparsity aware in-activate. In some embodiments, the operation circuit 200 operates according to the signal SPAR. In some embodiments, the operation circuit 200 disables some portions of the operation circuit 200 in response to the sparsity aware activate. In some embodiments, the zone detector circuit 104 generates an output with a number zero to the operation circuit 200 as a input of a integer operation according to the sparsity aware activate.

With reference to FIGS. 11A and 11B, in the INT mode, the operation circuit 200 performs integer operation including a MAC operation and an accumulation operation ADD to the result of the MAC operation. As shown in FIG. 11A, in some embodiments, the integer operations of a task1 and a task 2 that correspond to different inputs of integer is performed sequentially. As shown in FIG. 11B, in some embodiments, the integer operations of a task1 and a task 2 that correspond to different inputs of integer is performed with pipeline (performed at the same time).

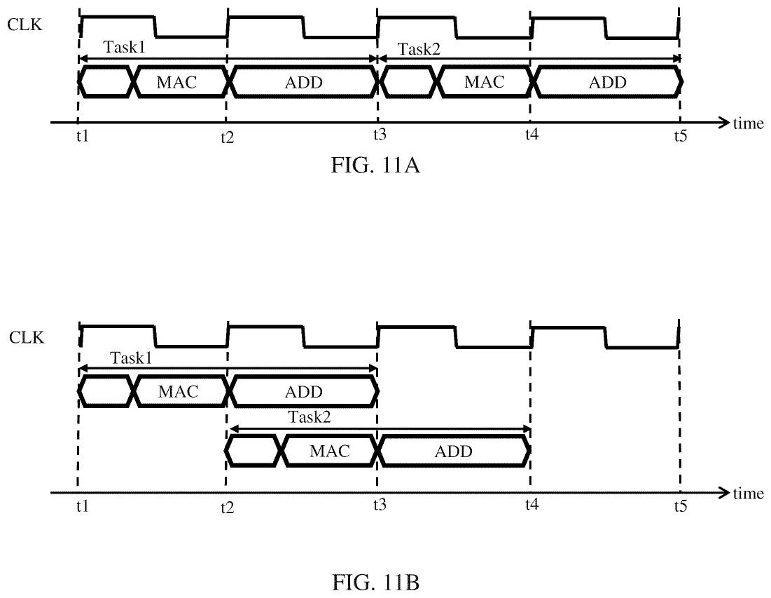

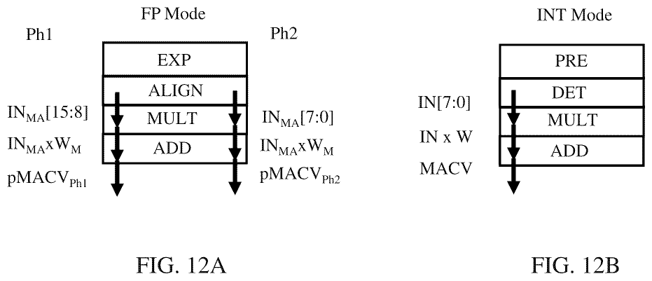

Reference is now made to FIGS. 12A-12B. FIG. 12A is a schematic diagram of an example of the floating mode corresponding to the system 10 of FIGS. 1-3, 4A-4B, 5-8, 9A-9B, 10 and 11A-11B, in accordance with various embodiments of the present disclosure. FIG. 12B is a schematic diagram of an example of the floating mode corresponding to the system 10 of FIGS. 1-3, 4A-4B, 5-8, 9A-9B, 10 and 11A-11B, in accordance with various embodiments of the present disclosure. With respect to the embodiments of FIGS. 1-3, 4A-4B, 5-8, 9A-9B, 10, and 11A-11B, like elements in FIGS. 12A-12B are designated with the same reference numbers for ease of understanding.

As shown in FIG. 12A, in the floating point (FP) mode, the system 10 performs an exponent operation EXP first to calculate products of exponents and/or find the maximum exponent. Then the system 10 performs the mantissa alignment operation ALIGN to generate aligned mantissas.

In a two phase mode, each of the aligned mantissas includes a phase Ph1 and a phase Ph2. Take an aligned mantissa IN_{MA} with bit width of sixteen includes for example, the more-significant eight bits IN_{MA}[15:8] corresponds to the phase Ph1 and the less-significant eight bits IN_{MA}[7:0] corresponds to the phase Ph1.

In the two phase mode, the system 10 performs a multiplication operation MULT and an addition operation ADD to the phases Ph1 and Ph2 separately to generate a partial MAC result pMAC_{Ph1} and a partial MAC result pMAC_{Ph2}. In some embodiments, the partial MAC result pMAC_{Ph1} and the partial MAC result pMAC_{Ph2} are combined to generate a more accurate MAC result.

As shown in FIG. 12B, in the integer (INT) mode, the system 10 performs an preprocess operation PRE of the integer data first. Then the system 10 performs the sparsity detection DET. When the sparsity aware is in-activate, the system 10 performs a multiplication operation MULT and an addition operation ADD to the input integer.

In some embodiments, the hardware for the floating mode and the integer mode is re-used. For example, the circuits for the exponent operation EXP in the floating point mode is re-used in the preprocess operation PRE in the integer mode. The circuits for the alignment operation ALIGN in the floating point mode is re-used in the sparsity detection DET in the integer mode.

The configurations of FIGS. 10, 11A-11B and 12A-12B are given for illustrative purposes. Various implements are within the contemplated scope of the present disclosure and. For example, in some embodiments, the zone detector circuit 104 outputs the signal SPAR to an input process circuit coupled between the zone detector circuit 104 and the operation circuit 200.

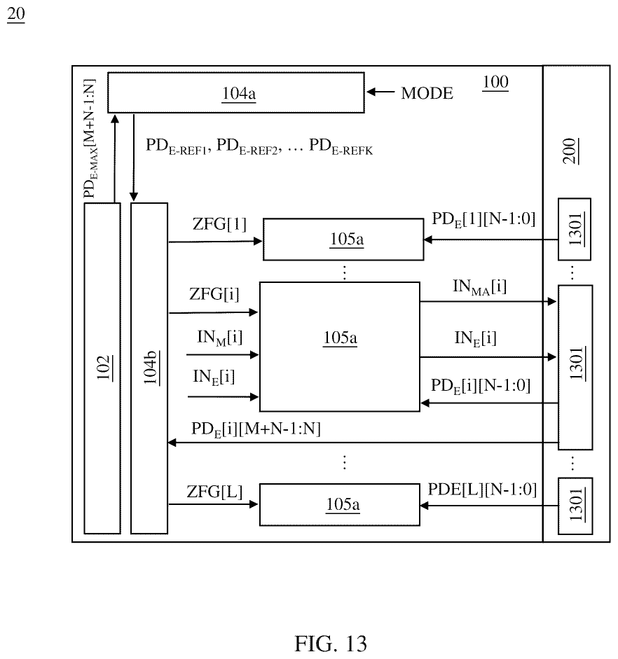

Reference is now made to FIG. 13. FIG. 13 is a schematic diagram of a system 20 configured with respect to the system 10 corresponding to FIGS. 1-3, 4A-4B, 5-8, 9A-9B, 10, 11A-11B and 12A-12B, in accordance with various embodiments of the present disclosure. With respect to the embodiments of FIGS. 1-3, 4A-4B, 5-8, 9A-9B, 10, 11A-11B and 12A-12B, like elements in FIG. 13 are designated with the same reference numbers for ease of understanding.

Compared with the zone detector circuit 104 of the system 10, the zone detector circuit 104 of the system 20 further includes a zone bias circuit 104a and a zone detector 104b. Compared with the alignment circuit 105 of the system 10, the alignment circuit 105 of the system 20 further includes multiple input processing circuit 105a. Compared with the operation circuit 200 of the system 10, the operation circuit 200 of the system 20 further includes multiple computing circuit 1301.

As shown in FIG. 13, the zone bias circuit 104a is coupled to the max finder circuit 102 and the zone detector 104b. The zone detector 104b is coupled to each input processing circuit 105a and each computing circuit 1301. Each input processing circuit 105a is coupled to a corresponding computing circuit 1301.

In some embodiments, the max finder circuit 102 outputs the PD_{E-MAX}[M+N−1:N] to the zone bias circuit 104a. The zone bias circuit 104a generates the references PD_{E-REF1} to PD_{E-REFK}.

Each computing circuit 1301 outputs one of the more-significant “M” bits PD_{E}[1] [M+N−1:N] to PD_{E}[N] [M+N−1:N] to the zone detector 104b. The zone detector 104b performs the zone detection as described in the paragraphs corresponding to the step s3 of method 300 to generate the zone flag ZFG[i] by comparing the more-significant “M” bits PD_{E}[i] [M+N−1:N] and the references PD_{E-REF1} to PD_{E-REFK}.

The input processing circuit 105a receives the zone flag ZFG[i], the mantissas IN_{M}[i], exponent IN_{E}[i] and the less-significant bits PD_{E}[i] [N−1:0]. The input processing circuit 105a performs the alignment to the mantissas IN_{M}[i] as described in the paragraphs corresponding to the step s4 of method 300 to generate the aligned mantissa IN_{MA}[i] according to the zone flag ZFG[i] and the less-significant bits PD_{E}[i] [N−1:0]. The input processing circuit 105a outputs the aligned mantissa IN_{MA}[i] and the exponent IN_{E}[i] to a corresponding computing circuit 1301. In some embodiments, the computing circuit 1301 performs a multiplication of the mantissa IN_{MA}[i] and a mantissa W_{M}[i] of the weight W[i].

In some embodiments, the zone bias circuit 104a receives the signal MODE. When the signal MODE indicates the INT mode, the zone bias circuit 104a set a reference as zero. The zone detector 104b compares the reference of zero and an input integer to output the signal SPAR.

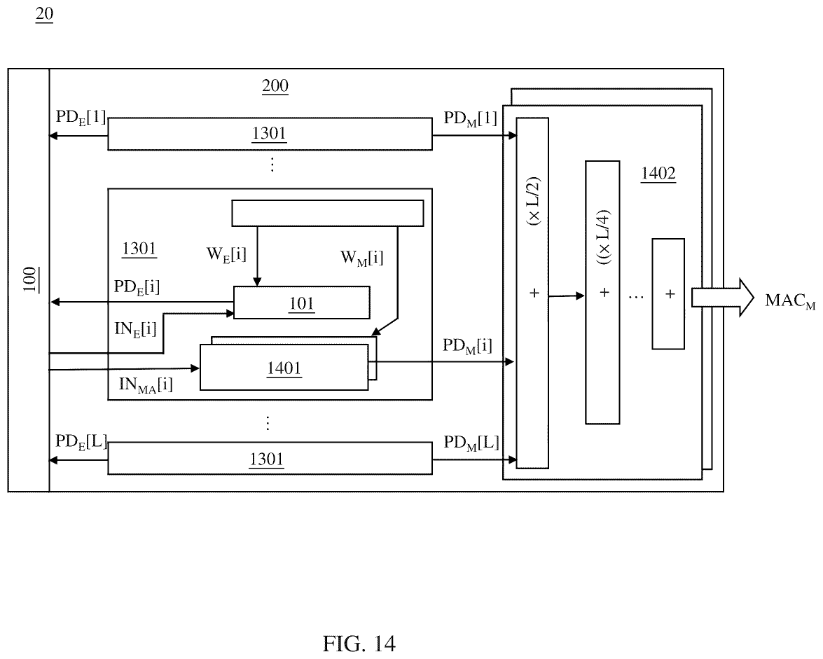

Reference is now made to FIG. 14. FIG. 14 is a schematic diagram of the system 20 corresponding to FIG. 13, in accordance with various embodiments of the present disclosure. With respect to the embodiments of FIGS. 1-3, 4A-4B, 5-8, 9A-9B, 10, 11A-11B, 12A-12B and 13, like elements in FIG. 14 are designated with the same reference numbers for ease of understanding.

Compared with the system 10 of shown in FIG. 2, instead of included in the data process circuit 100, the dual mode adder 101 of the system 20 is included in the computing circuit 1301. In some embodiments, each computing circuit 1301 includes a dual mode adder 101. In some embodiments, each computing circuit 1301 further includes multiple multipliers 1401.

In some embodiments, the operation circuit 200 of the system 20 further includes multiple adder trees 1402. In some embodiments, a first layer of the adder tree 1402 includes L/2 adders, a second layer of the adder tree 1402 includes L/4 adders, and so on, in which the number L equals to the number of computing circuits 1301. In some embodiments, the number of the adder trees 1402 equals to the number of the multipliers 1401 in each computing circuit 1301.

As shown in FIG. 14, the dual mode adder 101 is coupled to the data process circuit 100. The multiplier 1401 is coupled to the data process circuit 100 and the adder tree 1402.

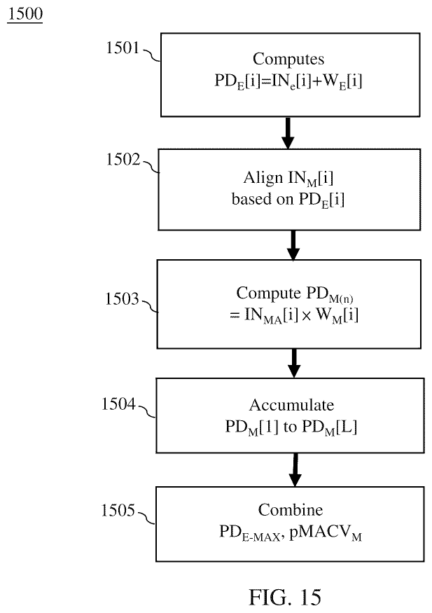

Reference is now further made to FIG. 15. FIG. 15 is a flowchart diagram of a method 1500 for operating the system 20 corresponding to FIGS. 13 and 14, in accordance with various embodiments of the present disclosure. It is understood that additional steps can be provided before, during, and after the steps shown by FIG. 15, and some of the steps described below can be replaced or eliminated, for additional embodiments of the method 1500. The order of the steps may be interchangeable. Throughout the various views and illustrative embodiments, like reference numbers are used to designate like elements. The method 1500 includes steps 1501 to 1505 that are described below with reference to the system 20, corresponding to FIGS. 13 and 14.

In step 1501, the dual mode adder 101 performs the addition between the exponent IN_{E}[i] of the input IN[i] and the exponent W_{E}[i] of the weight W[i] as described in the paragraphs corresponding to the step s1 of the method 300 to generate the product PD_{E}[i]. The computing circuit 1301 outputs the product PD_{E}[i] to the data process circuit 100.

In step 1502, the data process circuit 100 aligns the mantissa IN_{M}[i] based on the product PD_{E}[i]. In some embodiments, the data process circuit 100 outputs the aligned mantissa IN_{MA}[i] to the multipliers 1401.

In step 1503, the computing circuits 1301 computes a product PD_{M}[i] between the aligned mantissa IN_{MA}[i] and a mantissa W_{M}[i] of the weight W[i]. The multipliers 1401 performs a multiplication between the aligned mantissa IN_{MA}[i] and a mantissa W_{M}[i] to generate the product PD_{M}[i].

In step 1504, In some embodiments, the computing circuits 1301 output the products PD_{M}[1] to PD_{M}[L] to the adder trees 1402. The adder trees accumulate the products PD_{M}[1] to PD_{M}[L] to generate a result MAC_{M} of the MAC operation of the mantissas of the aligned mantissa and the mantissas of the weights.

In step 1505, the maximum PD_{E-MAX} and the result MAC_{M} are combined to generate a MAC result of the inputs IN[1] to IN[L] and the weights W[1] to W[L].

The configurations of FIGS. 13-15 are given for illustrative purposes. Various implements are within the contemplated scope of the present disclosure and. For example, in some embodiments, each input processing circuit 105a includes one inverter 113.

As described above, the present disclosure provides a system, a circuit and a method to perform mantissa alignment operations of floating point numbers. The proposed maximum product exponent search for mantissa alignment uses a portion of the exponent product instead of full bits. Using fewer bits simplifies routing and energy usage. In addition, with the proposed zone detector circuit, the mantissa alignment is performed according to relative exponent value and the mantissa bit shift is determined through direct inverse of a portion of product exponent. Compared to some approaches, the proposed circuit and method reduce data transfer by about 37%. Compared to some approaches, the proposed circuit and method reduce mantissa alignment energy usage by about 39% and area usage by about 14%.

In some embodiments, a circuit for data processing is provided. The circuit comprises a dual-mode adder, a max finder circuit, a zone detector circuit and an alignment circuit. The dual-mode adder generates products between first exponents of first floating point numbers and second exponents of second floating point numbers. The max finder circuit finds a maximum among first portions of the products. The zone detector circuit classifies the first portions into zones by comparing the first portions and the maximum. The alignment circuit align first mantissas of the first floating point numbers according to the zones and second portions of the products to generate aligned mantissas for a floating point number operation.

In some embodiments, the max finder circuit further comprises a register and a comparator circuit. The register stores a temporary maximum. The comparator circuit performs comparisons between the first portions and the temporary maximum, and updates the temporary maximum according to the comparisons, in which the temporary maximum is configured as the maximum after the comparisons are finished.

In some embodiments, the comparator circuit is a M-bits comparator, in which the number M is equal to a number of bits of each of the first portions, in which the number M is smaller than a number of bits of each of the products.

In some embodiments, the zone detector circuit further comprises a subtractor circuit. The subtractor circuit performs subtractions between the first portions and the maximum to generate references, and classify the first portions by comparing the first portions with the maximum and the references.

In some embodiments, the circuit further comprises metal lines with a number of M+1, coupled between the max finder circuit and the zone detector circuit to transmit the first portions and the maximum, in which the number M+1 of the metal lines is smaller than a number of bits of each of the products.

In some embodiments, the alignment circuit further comprises an inverter circuit. The inverter circuit performs inversions to the second portions to generate shifted bits number and generate the aligned mantissas according to the shifted bits.

In some embodiments, each of the inversions comprises a binary number that corresponds to a corresponding one of the shifted bits number.

In some embodiments, each of the aligned mantissas comprises first bits with a first bit width equal to a bit width of each of the first mantissas and comprises second bits as extension bits.

In some embodiments, the zone detector circuit further receives an integer number and generates a sparsity awareness signal according to a comparison between the integer number and a number of zero.

In some embodiments, when the integer number is smaller than zero, the zone detector circuit is further configured to generate the sparsity signal to disable a portion of a memory device that perform an integer operation to the integer number.

In some embodiments, a system for data processing is provided. The system comprises a data process circuit and a memory device. The data process circuit comprises a first comparator circuit, a second comparator circuit and an alignment circuit. The first comparator circuit finds a maximum among first portions of products between first activations and weights, in which the first activations and the weights are floating point numbers. The second comparator circuit compare the first portions of the products with references to generate zone flags. The references are according to the maximum. The alignment circuit align each of the first mantissas according to a corresponding zone flag of the zone flags to generate aligned mantissas. The memory device comprises a compute-in-memory (CIM) array. The CIM array performs a product-sum operation between the aligned mantissas and second mantissas of the weights.

In some embodiments, the second comparator circuit compares zero with second activations to determine whether the integer number is smaller than zero, wherein the plurality of second activations are integers, in which when the integer number is smaller than zero, the second comparator circuit generates a signal to disable a portion of the memory device.

In some embodiments, the system further comprises a register. The register stores a temporary maximum, in which the first comparator circuit performs comparisons between the first portions and the temporary maximum, and updates the temporary maximum according to the comparisons, in which the temporary maximum is configured as the maximum after the comparisons are finished.

In some embodiments, the alignment circuit aligns each of the first mantissas according to the corresponding zone flag and a corresponding one of second portions of the products.

In some embodiments, each of the aligned mantissas comprises first bits with a first bit width equal to a bit width of each of the first mantissas and comprises second bits as extension bits, in which the memory device is further perform the product-sum operation to the first bits and the second bits in parallel.

In some embodiments, a method for data processing is provided. The method comprises: adding first exponents of first floating point numbers and second exponents of second floating point numbers to generate products; identifying a maximum among first portions of the products; generating zone flags corresponding to the products according to the maximum, in which each of the zone flags indicates a zone that a corresponding one of the products is classified into; and aligning first mantissas of the first floating point numbers according to the zone flags and second portions of the products to generate aligned mantissas.

In some embodiments, generating zone flags comprises: determining references according to the maximum and a bit width of each of the second portions; and comparing the references and the products to generate the zone flags.

In some embodiments, the references have a common difference of 2N, in which N corresponds to the bit width of each of second portions.

In some embodiments, aligning the first mantissas comprising: determining inverse numbers of the second portions and aligning the first mantissas according to the inverse numbers and the zone flags.

In some embodiments, identifying the maximum comprises: sequentially comparing one of the first portions and a temporary maximum, and update the temporary maximum according to the comparing, in which the temporary maximum is configured as the maximum after comparing all of the first portions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit for data processing, comprising:
a dual-mode adder configured to generate a plurality of products between a plurality of first exponents of a plurality of first floating point numbers and a plurality of second exponents of a plurality of second floating point numbers;
a max finder circuit configured to find a maximum among a plurality of first portions of the plurality of products;
a zone detector circuit configured to classify the plurality of first portions into a plurality of zones by comparing the plurality of first portions and the maximum; and
an alignment circuit configured to align a plurality of first mantissas of the plurality of first floating point numbers according to the plurality of zones and a plurality of second portions of the plurality of products to generate a plurality of aligned mantissas for a floating point number operation.

2. The circuit of claim 1, wherein the max finder circuit further comprising:
a register configured to store a temporary maximum; and
a comparator circuit configured to perform a plurality of comparisons between the plurality of first portions and the temporary maximum, and to update the temporary maximum according to the comparisons, wherein the temporary maximum is configured as the maximum after the plurality of comparisons are finished.

3. The circuit of claim 2, wherein the comparator circuit is a M-bits comparator, wherein the number M is equal to a number of bits of each of the plurality of first portions, wherein the number M is smaller than a number of bits of each of the plurality of products.

4. The circuit of claim 1, wherein the zone detector circuit further comprises:
a subtractor circuit configured to perform a plurality of subtractions between the plurality of first portions and the maximum to generate a plurality of references,
wherein the zone detector circuit classifies the plurality of first portions by comparing the plurality of first portions with the maximum and the plurality of references.

5. The circuit of claim 1, further comprising:
a plurality of metal lines with a number of (M+1), coupled between the max finder circuit and the zone detector circuit to transmit the plurality of first portions and the maximum, wherein the number (M+1) of the plurality of metal lines is smaller than a number of bits of each of the plurality of products.

6. The circuit of claim 1, wherein the alignment circuit further comprises:
an inverter circuit configured to perform a plurality of inversions to the plurality of second portions to generate a plurality of shifted bits number and generate the plurality of aligned mantissas according to the plurality of shifted bits.

7. The circuit of claim 6, wherein each of the plurality of inversions comprises a binary number that corresponds to a corresponding one of the plurality of shifted bits number.

8. The circuit of claim 1, wherein each of the plurality of aligned mantissas comprises a plurality of first bits with a first bit width equal to a bit width of each of the plurality of first mantissas, and further comprises a plurality of second bits as a plurality of extension bits.

9. The circuit of claim 1, wherein the zone detector circuit is further configured to receive an integer number and to generate a sparsity awareness signal according to a comparison between the integer number and a number of zero.

10. The circuit of claim 9, wherein when the integer number is smaller than zero, the zone detector circuit is further configured to generate the sparsity awareness signal to disable a portion of a memory device that perform an integer operation to the integer number.

11. A system for data processing, comprising:
a data processing circuit comprising:
a first comparator circuit configured to find a maximum among a plurality of first portions of a plurality of products between a plurality of first activations and a plurality of weights, wherein the plurality of first activations and the plurality of weights are floating point numbers;
a second comparator circuit configured to compare the plurality of first portions of the plurality of products with a plurality of references to generate a plurality of zone flags, wherein the plurality of references are according to the maximum; and
an alignment circuit configured to align each of a plurality of first mantissas of the first activations according to a corresponding zone flag of the plurality of zone flags to generate a plurality of aligned mantissas; and
a memory device comprising:
a compute-in-memory (CIM) array configured to perform a product-sum operation between the plurality of aligned mantissas and a plurality of second mantissas of the plurality of weights.

12. The system of claim 11, wherein the second comparator circuit is further configured to compare zero with a plurality of second activations to determine whether a integer number is smaller than zero, wherein the plurality of second activations are integers,
wherein when the integer number is smaller than zero, the second comparator circuit is further configured to generate a signal to disable a portion of the memory device.

13. The system of claim 11, further comprising:
a register configured to store a temporary maximum, wherein the first comparator circuit is further configured to perform a plurality of comparisons between the plurality of first portions and the temporary maximum, and to update the temporary maximum according to the comparisons, wherein the temporary maximum is configured as the maximum after the plurality of comparisons are finished.

14. The system of claim 11, wherein the alignment circuit is further configured to align each of the plurality of first mantissas according to the corresponding zone flag and a corresponding one of a plurality of second portions of the plurality of products.

15. The system of claim 11, wherein each of the plurality of aligned mantissas comprises a plurality of first bits with a first bit width equal to a bit width of each of the plurality of first mantissas and comprises a plurality of second bits as a plurality of extension bits,
wherein the memory device is further configured to perform the product-sum operation to the plurality of first bits and the plurality of second bits at the same time.

16. A method for data processing, comprising:
adding a plurality of first exponents of a plurality of first floating point numbers and a plurality of second exponents of a plurality of second floating point numbers to generate a plurality of products;
identifying a maximum among a plurality of first portions of the plurality of products;
generating a plurality of zone flags corresponding to the plurality of products according to the maximum, wherein each of the plurality of zone flags indicates a zone that a corresponding one of the plurality of products is classified into; and
aligning a plurality of first mantissas of the plurality of first floating point numbers according to the plurality of zone flags and a plurality of second portions of the plurality of products to generate a plurality of aligned mantissas.

17. The method of claim 16, wherein generating the plurality of zone flags comprises:
determining a plurality of references according to the maximum and a bit width of each of the plurality of second portions; and
comparing the plurality of references and the plurality of products to generate the plurality of zone flags.

18. The method of claim 17, wherein the plurality of references have a common difference of 2^{N}, wherein N corresponds to the bit width of each of plurality of second portions.

19. The method of claim 16, wherein aligning the plurality of first mantissas comprises:
determining a plurality of inverse numbers of the plurality of second portions and aligning the plurality of first mantissas according to the plurality of inverse numbers and the plurality of zone flags.

20. The method of claim 16, wherein identifying the maximum comprises:
sequentially comparing one of the plurality of first portions and a temporary maximum, and update the temporary maximum according to the comparing, wherein the temporary maximum is configured as the maximum after comparing all of the plurality of first portions.
